(19) United States
(12) Patent Application Publication
(10) Pub. No.: US 2022/0136574 A1
(43) Pub. Date: May 5, 2022

(54) CLUTCH-BY-WIRE SYSTEM

(71) Applicant: HONDA MOTOR CO., LTD., Minato-ku, Tokyo (JP)

(72) Inventors: Tatsuya Ryuzaki, Wako-shi (JP); Yuta Kanbe, Wako-shi (JP); Go Morita, Wako-shi (JP); Junya Ono, Wako-shi (JP)

(21) Appl. No.: 17/434,773

(22) PCT Filed: Mar. 6, 2020
(86) PCT No.: PCT/JP2020/009587

§ 371 Date: Aug. 30, 2021

(30) Foreign Application Priority Data
Mar. 13, 2019 (JP) 2019-045693

(51) Int. Cl. F16D 48/06

(52) U.S. Cl. CPC F16D 48/06; F16D 2500/3108; F16D 2500/3166; F16D 2500/3146; F16D 2500/70605; F16D 2500/1117; F16D 2500/30808

(57) ABSTRACT

A clutch-by-wire system measures a position of a clutch lever (51) when predetermined learning permission conditions are satisfied and performs updating processing as a release position of the clutch lever (51) of updating a position which is previously stored. The clutch-by-wire system (51) repeatedly performs the updating processing after power is supplied.

### TECHNICAL FIELD

The present invention relates to a clutch-by-wire system. This application claims priority based on Japanese Patent Application No. 2019-045693, filed Mar. 13, 2019, the content of which is incorporated herein by reference.

### BACKGROUND ART

In the related art, there are clutch-by-wire systems in which a clutch lever and a clutch device are electrically coupled to each other. For example, a clutch-by-wire system includes an actuator that drives a clutch device, an operation amount detecting means for detecting the operation amount of the clutch lever, and an electronic control unit that controls operation of the actuator on the basis of a detection value of the operation amount detecting means.

For example, the electronic control unit calculates the operation amount based on a release position of the clutch lever which is not being operated by an occupant on the basis of the detection value of the operation amount detecting means. In this case, there is a need for the electronic control unit to store the release position of the clutch lever. For example, in the transmission disclosed in the following Patent Document 1, an output clutch torque capacity command value is associated with the operation amount of the clutch lever after power is supplied. Therefore, a control unit learns an operation range of the clutch lever using a signal range input from a lever operation amount detection unit.

### CITATION LIST

### Patent Literature

[Patent Document 1]

Japanese Patent No. 5639142

### SUMMARY OF INVENTION

### Technical Problem

However, in a clutch-by-wire system, for instance, when erroneous learning of an operation range of a clutch lever occurs, there is a probability that an operation of the clutch lever cannot be accurately transmitted to a clutch device.

Hence, the present invention provides a clutch-by-wire system in which erroneous learning of an operation range of a clutch lever can be promptly canceled.

### Solution to Problem

(1) According to an aspect of the present invention, there is provided a clutch-by-wire system for measuring a position of a clutch lever (51) when predetermined learning permission conditions are satisfied and performing updating processing of updating a position which is previously stored as a release position of the clutch lever (51). The updating processing is repeatedly performed after power is supplied.

According to the foregoing aspect, updating processing of updating a position which is previously stored as a release position of the clutch lever is repeatedly performed after power is supplied. Therefore, for instance, even if erroneous learning of the release position of the clutch lever occurs, the erroneous learning of the release position of the clutch lever can be promptly canceled without waiting for next power supply. Thus, in the clutch-by-wire system in which an operation range of the clutch lever is learned based on the stored release position of the clutch lever, erroneous learning of the operation range of the clutch lever can be promptly canceled.

(2) In the clutch-by-wire system according to the foregoing (1), the updating processing may be performed every time a predetermined amount of time elapses in a state in which the predetermined learning permission conditions are satisfied after power is supplied.

According to the foregoing aspect, when the predetermined learning permission conditions are satisfied, for instance, even if erroneous learning of the release position of the clutch lever occurs, the erroneous learning of the release position of the clutch lever can be canceled before a rider operates the clutch lever.

(3) The clutch-by-wire system according to the foregoing (1) or (2) may include a detection device (160) that detects the operation amount of the clutch lever (51). The learning permission conditions may include a condition that the detection value of the detection device (160) is within a predetermined learning permission range.

In the foregoing aspect, a state in which the detection value of the detection device is a value outside of the predetermined learning permission range corresponds to a state in which the clutch lever is positioned at a position that is drastically shifted from an original release position uniquely set in accordance with the shape of the clutch lever or the like. For this reason, it is possible to curb performing of the updating processing in a state inappropriate for updating the release position of the clutch lever, such as a state in which the clutch lever is being grasped (unreleased state) or a state in which the detection device has malfunctioned. Therefore, erroneous learning of the release position of the clutch lever can be curbed.

(4) In the clutch-by-wire system according to any one of the foregoing (1) to (3), the learning permission conditions may include a condition that the clutch lever (51) is positioned within a predetermined updating permission range based on the stored release position of the clutch lever (51).

In the foregoing aspect, a state in which the clutch lever is positioned outside of the predetermined updating permission range corresponds to a state in which the clutch lever is positioned at a position that is shifted from the stored release position of the clutch lever in a relatively significant manner. For this reason, it is possible to curb performing of the updating processing in a state inappropriate for updating the release position of the clutch lever, such as a state in which the clutch lever is being grasped (unreleased state) or a state in which the device for detecting the operation amount of the clutch lever has malfunctioned. Therefore, erroneous learning of the release position of the clutch lever can be curbed.

(5) In the clutch-by-wire system according to the foregoing (4), the predetermined updating permission range may be larger on a release side than on a grasp side of the clutch lever (51) with respect to the stored release position of the clutch lever (51).

According to the foregoing aspect, when the clutch lever stands still in a state of being grasped by a rider, it is possible to effectively curb updating of the release position of the clutch lever. Therefore, erroneous learning of the release position of the clutch lever can be curbed.

(6) In the clutch-by-wire system according to any one of the foregoing (1) to (5), the learning permission conditions may include a condition that the fluctuation range of an actual measurement value of the position of the clutch lever (51) is equal to or lower than a predetermined value.

The position of the clutch lever is likely to vibrate in a state in which the clutch lever is being grasped. According to the foregoing aspect, by performing the updating processing only when the fluctuation range of the actual measurement value of the position of the clutch lever is equal to or lower than a predetermined value, it is possible to curb updating of the release position of the clutch lever when the clutch lever is being grasped. Therefore, erroneous learning of the release position of the clutch lever can be curbed.

(7) In the clutch-by-wire system according to any one of the foregoing (1) to (6), the learning permission conditions may include a condition that an engine speed is equal to or lower than a predetermined value.

According to the foregoing aspect, it is possible to curb occurrence of an error in measurement results of the position of the clutch lever caused by vibration of the clutch lever due to vibration accompanied by rotation of an engine. Therefore, erroneous learning of the release position of the clutch lever can be curbed.

(8) In the clutch-by-wire system according to any one of the foregoing (1) to (7), the learning permission conditions may include a condition that a speed of a vehicle indicates a predetermined value.

According to the foregoing aspect, by performing the updating processing restrictively in a state in which the speed of the vehicle is zero (vehicle stop state), it is possible to curb occurrence of an error in measurement results of the position of the clutch lever caused by vibration of the clutch lever due to vibration from a road surface when the vehicle travels. Therefore, erroneous learning of the release position of the clutch lever can be curbed.

(9) In the clutch-by-wire system according to any one of the foregoing (1) to (8), the learning permission conditions may include a condition that a gear position is neutral.

When the gear position is not neutral, there is a high probability that the vehicle is traveling, and there is a high probability that the engine is rotating at a higher speed than a speed at the time of idling. According to the foregoing aspect, by performing the updating processing restrictively in a state in which the gear position is neutral, it is possible to curb occurrence of an error in measurement results of the position of the clutch lever caused by vibration of the clutch lever due to at least one of vibration from a road surface and vibration accompanied by rotation of the engine. Therefore, erroneous learning of the release position of the clutch lever can be curbed.

### Advantageous Effects of Invention

According to the foregoing clutch-by-wire system, erroneous learning of an operation range of a clutch lever can be promptly canceled.

### BRIEF DESCRIPTION OF DRAWINGS

FIG. 1 is a left side view of a motorcycle of an embodiment.

FIG. 2 is a schematic explanatory diagram of a clutch operation system including a clutch actuator.

FIG. 3 is a block diagram of a transmission system of the embodiment.

FIG. 4 is a plan view of a part around a clutch lever device of the embodiment.

FIG. 5 is a perspective view of the clutch lever device of the embodiment viewed from above on a front side.

FIG. 6 is a cross-sectional view of the clutch lever device of the embodiment viewed from above.

FIG. 7 is a cross-sectional view along line VII-VII in FIG. 4.

FIG. 8 is an explanatory diagram of operation of the clutch lever device of the embodiment.

FIG. 9 is a flowchart illustrating a flow of updating processing of a release position of a clutch lever in a clutch-by-wire system of the embodiment.

FIG. 10 is a timing chart illustrating an example of the updating processing of the release position of the clutch lever in the clutch-by-wire system of the embodiment.

FIG. 11 is a flowchart illustrating a flow of the updating processing of the release position of the clutch lever in the clutch-by-wire system of a modification example of the embodiment.

### DESCRIPTION OF EMBODIMENT

Hereinafter, an embodiment of the present invention will be described on the basis of the drawings. Unless otherwise specified in the following description, directions to the front, the rear, the left, the right, and the like are the same as directions in a vehicle, which will be described below. In addition, an arrow FR indicating a side in front of the vehicle, an arrow LH indicating the left side of the vehicle, and an arrow

UP indicating a side above the vehicle are marked in suitable places in the diagrams used in the following description.

<Entire Constitution of Vehicle>

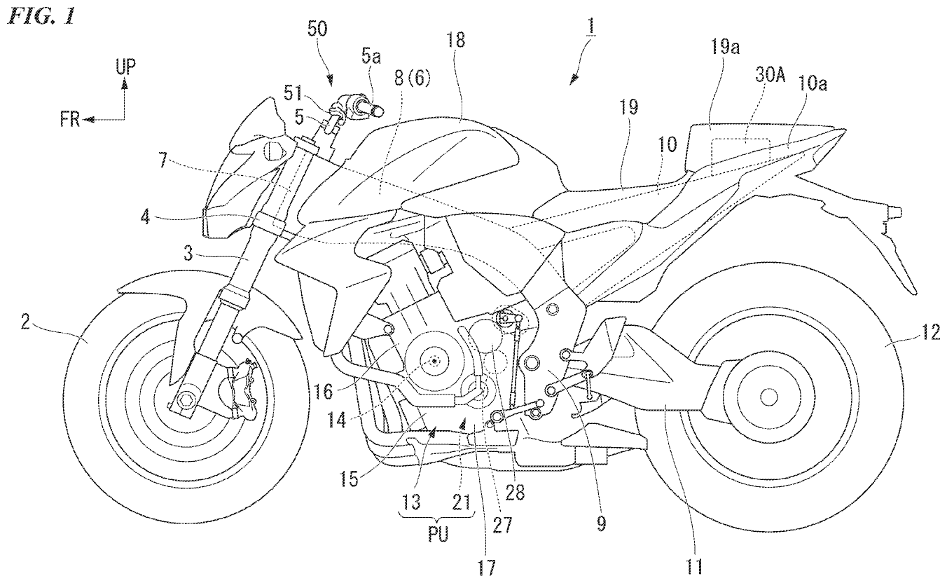

FIG. 1 is a left side view of a motorcycle of the embodiment.

As illustrated in FIG. 1, the present embodiment is applied to a motorcycle 1 which is a saddle-type vehicle. A front wheel 2 of the motorcycle 1 is supported by lower end portions of a pair of left and right front forks 3. Upper portions of the left and right front forks 3 are supported by a head pipe 7 at a front end portion of a vehicle body frame 6 via a steering stem 4. A steering handle bar 5 is attached to a top bridge above the steering stem 4. Grip portions 5a which a rider grasps are provided at respective outside portions of the handle bar 5 on the left and right sides.

The vehicle body frame 6 includes the head pipe 7, main tubes 8 which extend downward to the rear in the middle in a vehicle width direction from the head pipe 7, left and right pivot frames 9 which extend downward from rear end portions of the main tubes 8, and a seat frame 10 which extends rearward from the main tubes 8 and the left and right pivot frames 9. A front end portion of a swing arm 11 is pivotally supported by the left and right pivot frames 9 in a swingable manner. A rear wheel 12 of the motorcycle 1 is supported by a rear end portion of the swing arm 11.

A fuel tank 18 is supported above the left and right main tubes 8. Above the seat frame 10, a front seat cover 19 and a rear seat cover 19a are supported side by side in the front and back behind the fuel tank 18. A part around the seat frame 10 is covered with a rear cowl 10a. A power unit PU that is a prime mover of the motorcycle 1 is suspended below the left and right main tubes 8. The power unit PU is coupled to the rear wheel 12 via a chain-type power train mechanism, for example.

The power unit PU integrally has an engine 13 which is positioned at a front portion and a transmission 21 which is positioned at a rear portion. For example, the engine 13 is a multi-cylinder engine in which a rotary shaft of a crankshaft 14 lies in the vehicle width direction. The engine 13 includes cylinders 16 which stand upward at a front portion of a crankcase 15. A rear portion of the crankcase 15 serves as a transmission case 17 accommodating the transmission 21. The transmission 21 is a stepped transmission.

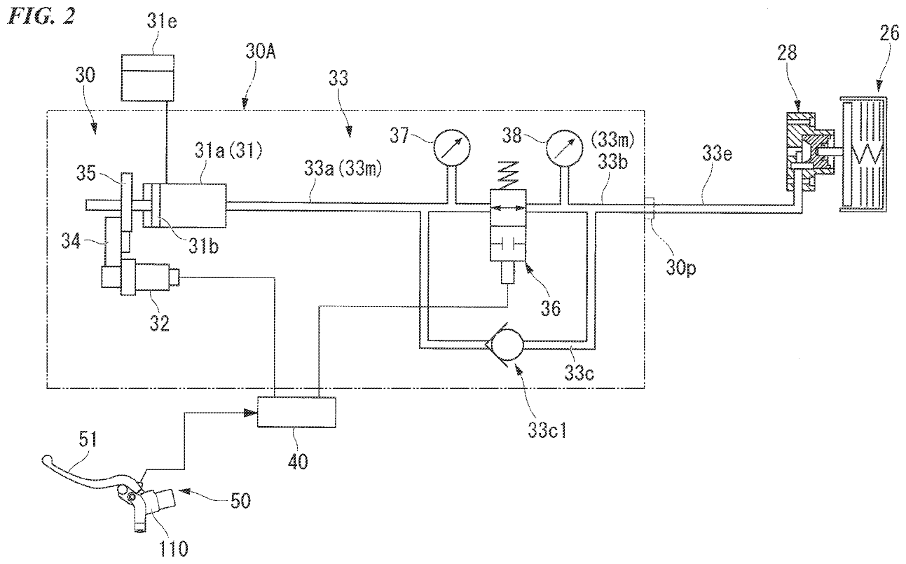

FIG. 2 is a schematic explanatory diagram of a clutch operation system including a clutch actuator.

As illustrated in FIGS. 1 and 2, a clutch device 26 operated by a clutch actuator 30 is disposed in the transmission 21. For example, the clutch device 26 is a wet multiplate clutch and is a so-called normally open clutch. That is, the clutch device 26 is in a connected state in which power can be transmitted due to a hydraulic pressure supplied from the clutch actuator 30 and returns to a disconnected state in which power cannot be transmitted when a hydraulic pressure is no longer supplied from the clutch actuator 30.

Rotary power of the crankshaft 14 is transmitted to the transmission 21 via the clutch device 26. A drive sprocket 27 of the chain-type power train mechanism is attached to the transmission 21.

<Transmission System>

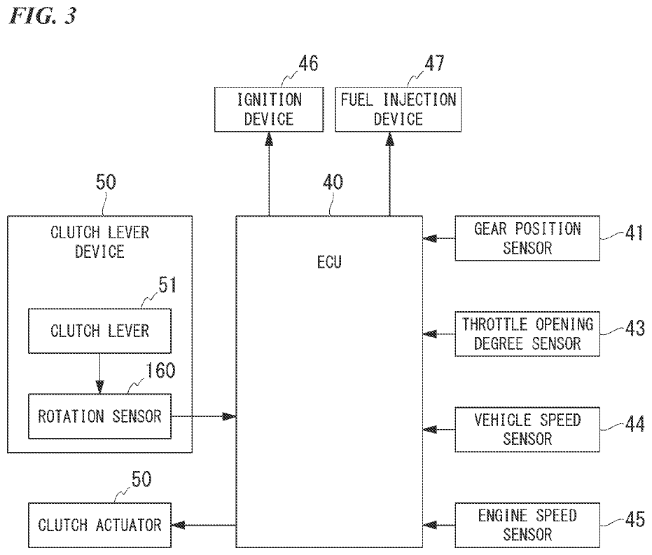

FIG. 3 is a block diagram of a transmission system of the embodiment. Here, as illustrated in FIG. 3, the transmission system of the motorcycle 1 includes the clutch actuator 30, an electronic control unit 40 (ECU), a clutch lever device 50, and various sensors and employs a clutch-by-wire system in which the clutch device 26 and a clutch lever 51 (which will be described below) are electrically connected to each other.

The ECU 40 controls operation of the clutch actuator 30 and controls operation of an ignition device 46 and a fuel injection device 47 on the basis of various pieces of vehicle state detection information and the like from a gear position sensor 41, a throttle opening degree sensor 43, a vehicle speed sensor 44, an engine speed sensor 45, and the like. Detection information from a rotation sensor 160 (detection device) of the clutch lever device 50 (which will be described below) is also input to the ECU 60. The ECU 60 includes memories 62 such as a read only memory (ROM) and a random access memory (RAM), in addition to a central processing unit (CPU).

As illustrated in FIG. 2, operation of the clutch actuator 30 is controlled by the ECU 40 so as to be able to control the fluid pressure for connecting and disconnecting the clutch device 26. The clutch actuator 30 includes an electric motor 32 (which will hereinafter be simply referred to as a motor 32) which serves as a drive source, and a master cylinder 31 which is driven by the motor 32. The clutch actuator 30 constitutes an integrated clutch control unit 30A together with a hydraulic circuit device 33 provided between the master cylinder 31 and a hydraulic pressure supplying/discharging port 30p.

The ECU 40 computes a target value for a hydraulic pressure (target hydraulic pressure) supplied to a slave cylinder 28 in order to connect and disconnect the clutch device 26 on the basis of a position of the clutch lever 51 and a computation program set in advance. The ECU 40 controls the clutch control unit 30A such that the hydraulic pressure on the slave cylinder 28 side (slave hydraulic pressure) detected by a downstream side hydraulic pressure sensor 38 becomes close to the target hydraulic pressure. The ECU 40 measures the position of the clutch lever 51 from a detection value of the rotation sensor 160 of the clutch lever device 50. A method of measuring the position of the clutch lever 51 performed by the ECU 40 will be described below.

The master cylinder 31 strokes a piston 31b inside a cylinder main body 31a in accordance with driving of the motor 32 such that hydraulic oil inside the cylinder main body 31a can be supplied and discharged with respect to the slave cylinder 28. In the diagram, the reference sign 35 indicates a conversion mechanism which serves as a ball screw mechanism, the reference sign 34 indicates a transmission mechanism which straddles the motor 32 and the conversion mechanism 35, and the reference sign 31e indicates a reservoir which is connected to the master cylinder 31, respectively.

The hydraulic circuit device 33 has a valve mechanism (solenoid valve 36) for opening or blocking an intermediate part of a main oil passage 33m extending from the master cylinder 31 to the clutch device 26 side (slave cylinder 28 side). The main oil passage 33m of the hydraulic circuit device 33 is divided into an upstream side oil passage 33a on the master cylinder 31 side of the solenoid valve 36 and a downstream side oil passage 33b on the slave cylinder 28 side of the solenoid valve 36. The hydraulic circuit device 33 further includes a bypass oil passage 33c which bypasses the solenoid valve 36 and allows the upstream side oil passage 33a and the downstream side oil passage 33b to communicate with each other.

The solenoid valve 36 is a so-called normally open valve. A one-way valve 33c1 for circulating hydraulic oil in only a direction from the upstream side to the downstream side is provided in the bypass oil passage 33c. An upstream side hydraulic pressure sensor 37 for detecting the hydraulic pressure in the upstream side oil passage 33a is provided on the upstream side of the solenoid valve 36. The downstream side hydraulic pressure sensor 38 for detecting the hydraulic pressure in the downstream side oil passage 33b is provided on the downstream side of the solenoid valve 36.

As illustrated in FIG. 1, for example, the clutch control unit 30A is accommodated inside the rear cowl 10a. The slave cylinder 28 is attached to the left side of the rear portion of the crankcase 15. The clutch control unit 30A and the slave cylinder 28 are connected to each other via a hydraulic piping 33e (refer to FIG. 2).

As illustrated in FIG. 2, the slave cylinder 28 operates the clutch device 26 such that it is brought into a connected state when a hydraulic pressure is supplied from the clutch actuator 30. The slave cylinder 28 returns the clutch device 26 to a disconnected state when the hydraulic pressure is no longer supplied.

There is a need to continue supplying of a hydraulic pressure in order to maintain the clutch device 26 in a connected state, and therefore electricity according to this amount is consumed. Hence, the solenoid valve 36 is provided in the hydraulic circuit device 33 of the clutch control unit 30A, and the solenoid valve 36 is closed after a hydraulic pressure is supplied to the clutch device 26 side. Accordingly, consumption of energy is curbed due to a constitution in which a hydraulic pressure supplied to the clutch device 26 side is maintained and the hydraulic pressure is supplemented according to the amount of reduction in pressure (recharged according to the amount of leakage).

<Constitution of Clutch Lever Device>

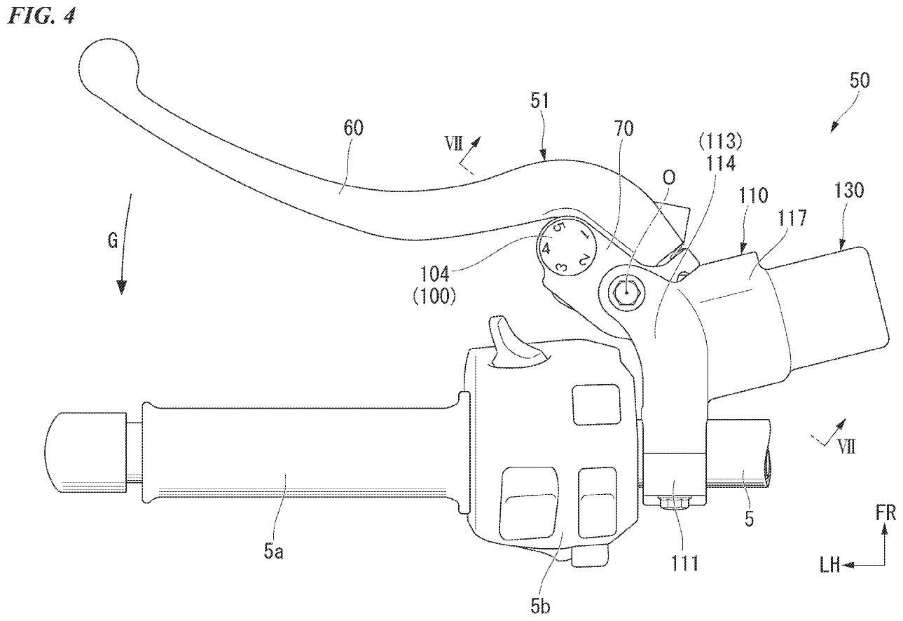

FIG. 4 is a plan view of a part around a clutch lever device of the embodiment.

As illustrated in FIG. 4, the clutch lever device 50 is attached to the handle bar 5 such that it lies along the grip portion 5a on the left side. The clutch lever device 50 requires no mechanical connection with the clutch device 26 using a cable, a hydraulic pressure, or the like and functions as an operation tool for transmitting a clutch operation request signal to the ECU 40.

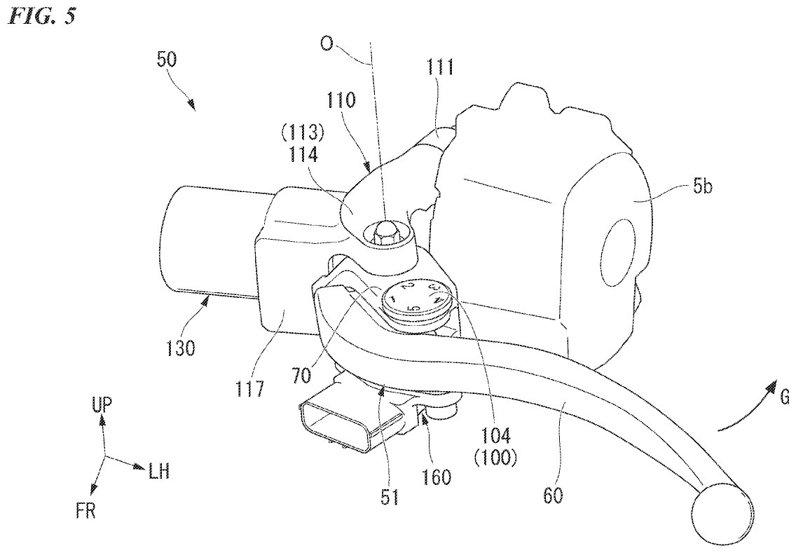

FIG. 5 is a perspective view of the clutch lever device of the embodiment viewed from above on a front side.

As illustrated in FIGS. 4 and 5, the clutch lever device 50 includes the clutch lever 51 which is operated by an occupant and turns around a rotation axis O, a lever holder 110 which turnably supports the clutch lever 51, a reaction force generation device 130 which generates an operation reaction force in the clutch lever 51, and the rotation sensor 160 which detects the operation amount of the clutch lever 51.

Unless otherwise specified in the following description related to the shape of the clutch lever device 50, a state in which the clutch lever 51 is not being operated will be described. In addition, regarding the position of the clutch lever 51, a position in a state in which the clutch lever 51 is not being operated will be referred to as a release position. In addition, regarding a circumferential direction around the rotation axis O, a direction in which the clutch lever 51 turns from the release position when it is operated will be defined as an operation direction G. In addition, in the following description, a direction in which the rotation axis O extends will be referred to as an axial direction. In the present embodiment, for the sake of convenience, the axial direction is assumed to be a direction that coincides with a vertical direction.

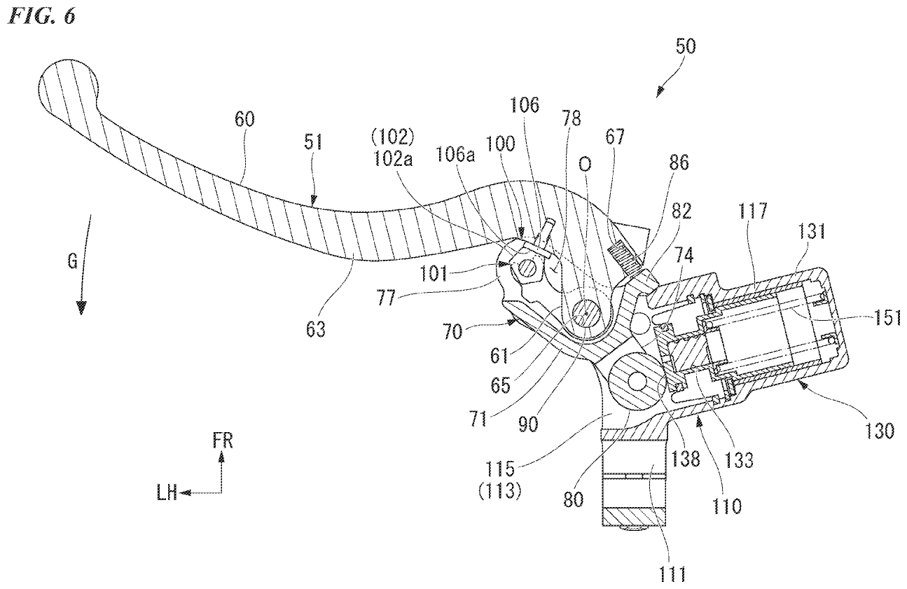

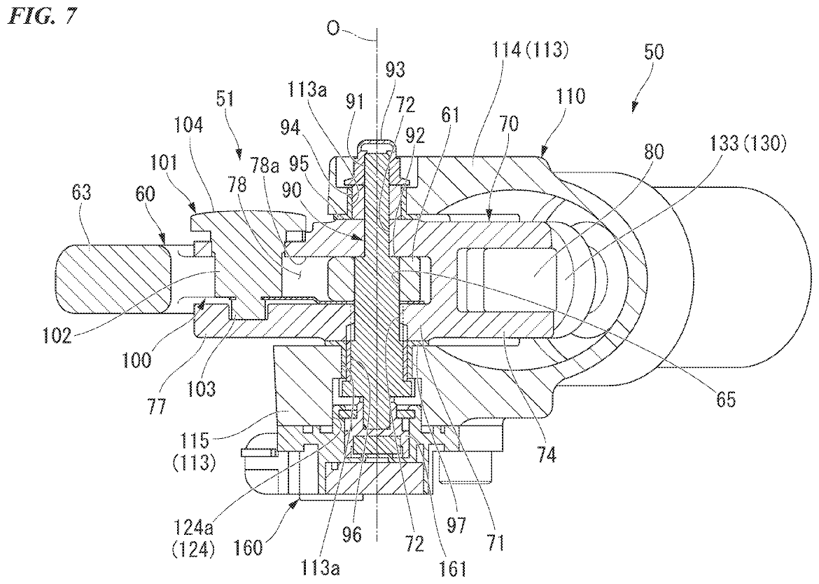

The lever holder 110 is attached to an inner side (right side) in the vehicle width direction from the grip portion 5a on the left side in the handle bar 5. The lever holder 110 includes a fixed portion 111 which is fixed to the handle bar 5, a lever support portion 113 which extends from the fixed portion 111 and supports the clutch lever 51, a piston holding portion 117 which is connected to the fixed portion 111 and the lever support portion 113 and holds a piston 133 (refer to FIG. 6) of the reaction force generation device 130, and a rotation sensor holding portion 124 (refer to FIG. 7) which holds the rotation sensor 160.

As illustrated in FIG. 4, the fixed portion 111 is fixed to the handle bar 5 on a side opposite to the grip portion 5a on the left side with a switch box 5b sandwiched therebetween. The fixed portion 111 includes a front half body which is fitted to a front half circumferential surface of the handle bar 5, and a rear half body which is fitted to a rear half circumferential surface of the handle bar 5. The front half body and the rear half body of the fixed portion 111 are joined to each other using a bolt such that the handle bar 5 is sandwiched therebetween.

The lever support portion 113 extends from the fixed portion 111 in a direction orthogonal to the axial direction (also refer to FIG. 5). The lever support portion 113 includes an upper support portion 114 and a lower support portion 115 (refer to FIG. 6). The upper support portion 114 and the lower support portion 115 extend in a manner of being parallel to each other with a gap therebetween in the axial direction such that a proximal part of the clutch lever 51 is sandwiched therebetween. The upper support portion 114 and the lower support portion 115 are curved after extending forward from the fixed portion 111 and extend forward and outward in the vehicle width direction when viewed in the vertical direction. A penetration hole 113a (refer to FIG. 7) coaxial with the rotation axis O is formed in the upper support portion 114 and the lower support portion 115.

FIG. 6 is a cross-sectional view of the clutch lever device of the embodiment viewed from above.

As illustrated in FIG. 6, the piston holding portion 117 is formed to have a cylindrical shape and extends inward in the vehicle width direction from the lever support portion 113. The piston holding portion 117 is coupled to the fixed portion 111, the upper support portion 114, and the lower support portion 115. An end portion of the piston holding portion 117 on the lever support portion 113 side is open to a space between the upper support portion 114 and the lower support portion 115. Another end portion of the piston holding portion 117 on a side opposite to the lever support portion 113 is closed. The piston holding portion 117 forms a cylinder 131 of the reaction force generation device 130.

FIG. 7 is a cross-sectional view along line VII-VII in FIG. 4.

As illustrated in FIG. 7, the rotation sensor holding portion 124 is provided in the lever support portion 113. The rotation sensor holding portion 124 is provided on a lower surface of the lower support portion 115 of the lever support portion 113. The rotation sensor holding portion 124 includes a recessed portion 124a which is recessed upward. A lower end portion of the penetration hole 113a is open at the recessed portion 124a. A part of the rotation sensor 160 is inserted into the recessed portion 124a from below.

As illustrated in FIG. 6, the reaction force generation device 130 has a piston structure. The reaction force generation device 130 elastically extends and contracts so as to apply an operation reaction force to the clutch lever 51. The reaction force generation device 130 includes the cylinder 131, the piston 133, and a spring 151. The cylinder 131 is the piston holding portion 117. The piston 133 is inserted into the inner side of the cylinder 131. The spring 151 is interposed between the cylinder 131 and the piston 133.

The piston 133 is a member which the clutch lever 51 abuts. The piston 133 is formed to have a bottomed cylindrical shape and disposed coaxially with the cylinder 131. A distal end surface 138 which the clutch lever 51 abuts is provided at an end portion of the piston 133 on the lever support portion 113 side.

The spring 151 biases the piston 133 to the lever support portion 113 side with respect to the cylinder 131. The spring 151 is a compression coil spring and is disposed coaxially with the piston 133. The spring 151 is formed to have a smaller diameter than that of an inner circumferential surface of the piston 133. The spring 151 is disposed across the inner side of the piston 133 from the inner side of the cylinder 131.

As illustrated in FIG. 4, the clutch lever 51 a clutch operation tool operated by an occupant. The clutch lever 51 is disposed in front of the grip portion 5a on the left side.

As illustrated in FIG. 6, the clutch lever 51 is formed to be turned by an operation of an occupant and to press the piston 133. The clutch lever 51 includes a lever main body 60 which an occupant touches and operates; a knocker 70 which is provided separately from the lever main body 60, is engaged with the lever main body 60, and turns together with the lever main body 60; and a support shaft 90 which is disposed coaxially with the rotation axis O and turns around the rotation axis O together with the lever main body 60 and the knocker 70. In the present embodiment, the lever main body 60 and the knocker 70 are provided as separate members, but they may be integrally formed as one member.

As illustrated in FIGS. 6 and 7, the knocker 70 is disposed between the upper support portion 114 and the lower support portion 115 of the lever support portion 113. The knocker 70 is provided to be able to turn around the rotation axis O with respect to the lever support portion 113. The knocker 70 includes a base portion 71 which is supported by the support shaft 90, a first arm 74 and a second arm 77 which extend from the base portion 71, and a roller 80 which is supported by the first arm 74.

As illustrated in FIG. 7, a support shaft insertion hole 72, through which the support shaft 90 is inserted, is formed in the base portion 71. The support shaft insertion hole 72 penetrates the base portion 71 along the rotation axis O. The support shaft insertion hole 72 is formed to have a circular shape when viewed in the axial direction. The support shaft insertion hole 72 is subjected to spline processing such that the knocker 70 and the support shaft 90 can integrally rotate.

As illustrated in FIG. 6, the first arm 74 extends rearward and inward in the vehicle width direction from the base portion 71 when viewed in the vertical direction.

The first arm 74 extends in a direction orthogonal to the axial direction from the base portion 71. A distal end of the first arm 74 is provided in a manner of facing the distal end surface 138 of the piston 133. The distal end of the first arm 74 rotatably supports the roller 80 (refer to FIG. 7). The roller 80 is provided in a manner of being rotatable around an axis parallel to the rotation axis O. The roller 80 abuts the distal end surface 138 of the piston 133. The roller 80 abuts the distal end surface 138 of the piston 133 from the upstream side in the operation direction G. The roller 80 rolls on the distal end surface 138 of the piston 133 in accordance with turning of the knocker 70.

The second arm 77 extends to a side opposite to the first arm 74 from the base portion 71. That is, the second arm 77 extends forward and outward in the vehicle width direction from the base portion 71 when viewed in the vertical direction. The second arm 77 extends in a direction orthogonal to the axial direction from the base portion 71.

As illustrated in FIGS. 6 and 7, a recessed portion 78 accommodating a turning base portion 61 of the lever main body 60 is formed in the knocker 70. The recessed portion 78 is recessed rearward and is open forward in a direction orthogonal to the axial direction. The recessed portion 78 is formed across the base portion 71 from the second arm 77.

As illustrated in FIG. 6, the knocker 70 further includes an abutment portion 82. The abutment portion 82 protrudes in a direction orthogonal to the axial direction from the base portion 71. The abutment portion 82 extends forward and inward in the vehicle width direction from the base portion 71 when viewed in the vertical direction. A distal end portion of the abutment portion 82 abuts a place toward the downstream side in the operation direction G in the piston holding portion 117 of the lever holder 110 from the downstream side in the operation direction G. Turning of the knocker 70 in a direction opposite to the operation direction G is restricted due to the abutment portion 82 abutting the piston holding portion 117. When the abutment portion 82 abuts the piston holding portion 117, the knocker 70 is positioned at an end portion on the upstream side in the operation direction G within a turning range. A state in which the abutment portion 82 abuts the piston holding portion 117 is a state in which the clutch lever 51 is not being operated (not grasped). That is, when the abutment portion 82 abuts the piston holding portion 117, the clutch lever 51 is at the release position. Accordingly, the release position of the clutch lever 51 is uniquely set in accordance with the shape of the clutch lever device 50.

As illustrated in FIGS. 6 and 7, the lever main body 60 includes the turning base portion 61 which is supported by the support shaft 90, and an operation portion 63 which extends to a side in front of the grip portion 5a on the left side from the turning base portion 61. The turning base portion 61 is inserted into the recessed portion 78 of the knocker 70 and is sandwiched in the knocker 70 from both sides in the axial direction. A support shaft insertion hole 65 is formed in the turning base portion 61. The support shaft insertion hole 65 penetrates the turning base portion 61 along the rotation axis O. The support shaft insertion hole 65 is formed to have a circular shape when viewed in the axial direction.

As illustrated in FIG. 6, the operation portion 63 extends outward in the vehicle width direction from a front portion of the turning base portion 61. An end portion of the operation portion 63 on the inner side in the vehicle width direction faces the abutment portion 82 of the knocker 70 with a gap therebetween from the downstream side in the operation direction G. A returning spring accommodation portion 67 is formed at the end portion of the operation portion 63 on the inner side in the vehicle width direction. The returning spring accommodation portion 67 is formed on a side surface toward the upstream side in the operation direction G. The returning spring accommodation portion 67 is a recessed portion opening toward the upstream side in the operation direction G. The returning spring accommodation portion 67 is formed at a position facing the abutment portion 82 of the knocker 70. A return spring 86 (compression coil spring) is inserted into the returning spring accommodation portion 67. The return spring 86 biases the lever main body 60 to the knocker 70 in the operation direction G.

An adjustment mechanism 100 is interposed between the lever main body 60 and the knocker 70. The adjustment mechanism 100 is a mechanism for adjusting a grasp margin between the grip portion 5a and the lever main body 60. The adjustment mechanism 100 includes an adjustment pin 101 which is rotatably mounted in the second arm 77 of the knocker 70 and a cam abutment member 106 which is mounted in the lever main body 60.

As illustrated in FIGS. 6 and 7, the adjustment pin 101 is provided in a manner of being rotatable around an axis parallel to the axial direction. The adjustment pin 101 includes a cam clutch portion 102 which is disposed in the recessed portion 78 of the knocker 70, a shaft portion 103 which extends from the cam clutch portion 102 to both sides in the axial direction, and an operation dial 104 which is provided in the shaft portion 103. The cam clutch portion 102 is disposed on the downstream side in the operation direction G with respect to the operation portion 63 of the lever main body 60. The cam clutch portion 102 is formed to have a pentagonal shape when viewed in the axial direction and has a plurality (five in the present embodiment) of cam surfaces 102a in the outer circumference. The plurality of cam surfaces 102a are respectively provided at different distances from a center axis of the adjustment pin 101. The shaft portion 103 is rotatably supported by the second arm 77 of the knocker 70 on both upper and down sides sandwiching the cam clutch portion 102 therebetween. The operation dial 104 is provided at an upper end of the shaft portion 103. The operation dial 104 is disposed along an upper surface of the second arm 77 of the knocker 70. The operation dial 104 can be operated to rotate by an occupant.

As illustrated in FIG. 6, the cam abutment member 106 is a member having a cam abutment surface 106a abutting the cam surfaces 102a of the cam clutch portion 102. The cam abutment surface 106a abuts any of the plurality of cam surfaces 102a of the cam clutch portion 102 from the upstream side in the operation direction G. Accordingly, the lever main body 60 is engaged with the knocker 70. Since the lever main body 60 is biased in the operation direction G by the return spring 86, it is in a state of being engaged with the knocker 70 at all times.

As illustrated in FIG. 7, the support shaft 90 is a bolt having a screw shaft 91 provided at the distal end. The support shaft 90 is inserted through the penetration hole 113a of the lever holder 110 and the support shaft insertion holes 72, 65 of the clutch lever 51 from below. The screw shaft 91 protrudes to a side above the lever holder 110. The support shaft 90 supports the lever main body 60 such that it can relatively turn.

The support shaft 90 supports the knocker 70 such that it cannot relatively rotate. A stepped surface 92 toward an upper side in the axial direction is formed on an outer circumferential surface of the support shaft 90. The stepped surface 92 extends along a perpendicular plane of the rotation axis O.

The support shaft 90 is attached to the lever holder 110 by screwing the screw shaft 91 into a nut 93. The stepped surface 92 of the support shaft 90 abuts a top surface 78a of the recessed portion 78 of the knocker 70 as a seat surface. The nut 93 is fastened to the base portion 71 of the knocker 70 via a cylindrical first spacer 94 externally inserted into an upper portion of the support shaft 90. Accordingly, the base portion 71 of the knocker 70 is fixed to the support shaft 90 due to a fastening force of the nut 93 in a state of being sandwiched between the stepped surface 92 of the support shaft 90 and the first spacer 94. An upper portion of the support shaft 90 is supported in a slidable manner with respect to the upper support portion 114 of the lever holder 110 via a first bush 95 externally inserted into the first spacer 94. A lower portion of the support shaft 90 is supported in a slidable manner with respect to the lower support portion 115 of the lever holder 110 via a cylindrical second spacer 96 externally inserted into a lower portion of the support shaft 90 and a second bush 97 externally inserted into the second spacer 96.

The rotation sensor 160 converts the operation amount of the clutch lever 51 into an electric signal and outputs the electric signal. For example, the rotation sensor 160 is a potentiometer, for example. The rotation sensor 160 changes an output voltage in accordance with the operation amount of the clutch lever 51. In the present embodiment, the output voltage of the rotation sensor 160 increases as the operation amount of the clutch lever 51 increases.

The rotation sensor 160 is disposed below the lever main body 60. The rotation sensor 160 is attached to the lever holder 110. The rotation sensor 160 is fastened to the rotation sensor holding portion 124 using a bolt or the like in a state in which a part thereof is inserted into the recessed portion 124a of the rotation sensor holding portion 124. A turning detection tool 161 of the rotation sensor 160 is disposed coaxially with a rotation center (rotation axis O) of the clutch lever 51 and is joined to a lower end portion of the support shaft 90 in an integrally turnable manner. The rotation sensor 160 detects a rotation angle of the knocker 70 turning integrally with the support shaft 90 by detecting a rotation angle of the support shaft 90. Since the knocker 70 turns integrally with the lever main body 60, the rotation sensor 160 can detect the operation amount of the clutch lever 51. The operation amount of the clutch lever 51 detected by the rotation sensor 160 is input to the ECU 40.

<Operation of Clutch Lever Device>

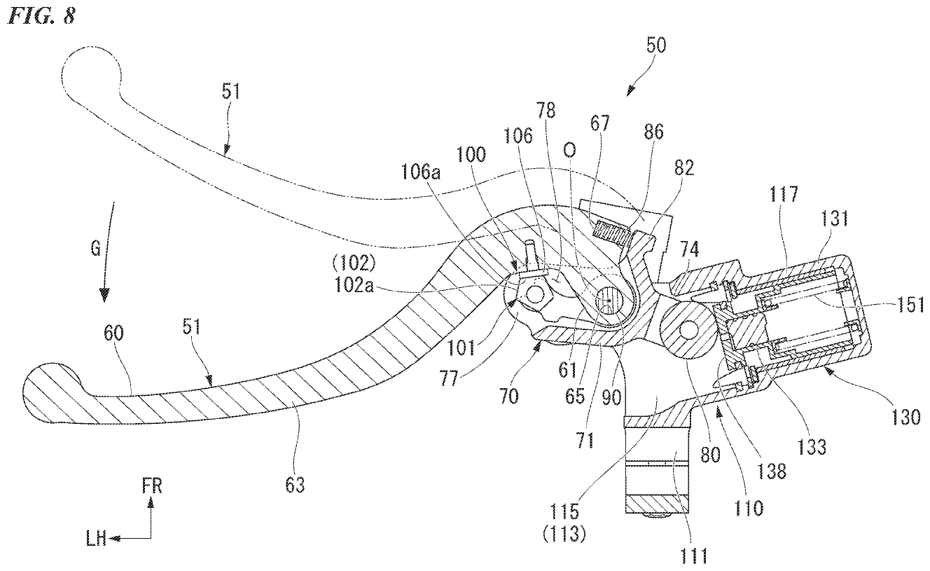

Next, operation of the clutch lever device of the present embodiment will be described with reference to FIG. 8.

FIG. 8 is an explanatory diagram of operation of the clutch lever device of the embodiment and is a partial cross-sectional view of the clutch lever device viewed from above.

When power transmission of the clutch device 26 is disconnected, the lever main body 60 is operated so as to turn in the operation direction G with respect to the release position. If the lever main body 60 turns in the operation direction G, the knocker 70 engaged with the lever main body 60 also turns in the operation direction G together with the lever main body 60. If the knocker 70 turns in the operation direction G, the roller 80 is displaced in the operation direction G and presses the piston 133 while rolling on the distal end surface 138 of the piston 133. The reaction force generation device 130 contracts when the piston 133 is pressed by the knocker 70.

The piston 133 is biased in a direction in which it extends due to the spring 151. For this reason, a force in a direction opposite to the operation direction G acts on the roller 80. That is, the reaction force generation device 130 presses the knocker 70 such that the knocker 70 turns to a side opposite to that in the operation direction G. If the knocker 70 is pressed in a direction opposite to the operation direction G, the lever main body 60 engaged with the knocker 70 is also pressed in a direction opposite to the operation direction G. Accordingly, an operation reaction force is generated in the lever main body 60. When an occupant loosens grasp of the lever main body 60, the lever main body 60 turns in a direction opposite to the operation direction G together with the knocker 70 and returns to the release position.

<Method of Measuring Position of Clutch Lever>

Next, the method of measuring the position of the clutch lever 51 performed by the ECU 40 will be described.

The ECU 40 measures the position of the clutch lever 51 from the detection value (output voltage) of the rotation sensor 160 and controls the clutch control unit 30A in accordance with the measured position of the clutch lever 51. The position of the clutch lever 51 corresponds to the operation amount of the clutch lever 51 when it is based on the release position of the clutch lever 51. Namely, the position of the clutch lever 51 corresponds to a turning angle from the release position of the clutch lever 51. The ECU 40 stores the release position of the clutch lever 51 in association with the detection value of the rotation sensor 160. Hereinafter, the detection value of the rotation sensor 160 corresponding to the release position of the clutch lever 51 stored by the ECU 40 will be referred to as a release position voltage.

In the clutch-by-wire system of the present embodiment, the position of the clutch lever 51 is measured when predetermined learning permission conditions are satisfied and performs updating processing of updating and recording a position which has been previously stored as the release position of the clutch lever 51. Moreover, the clutch-by-wire system repeatedly performs the updating processing after power is supplied to the vehicle. The predetermined learning permission conditions include first to third permission conditions related to states of the vehicle and fourth to seventh permission conditions related to states of the clutch lever device 50. Hereinafter, the updating processing in the clutch-by-wire system of the present embodiment will be described in detail.

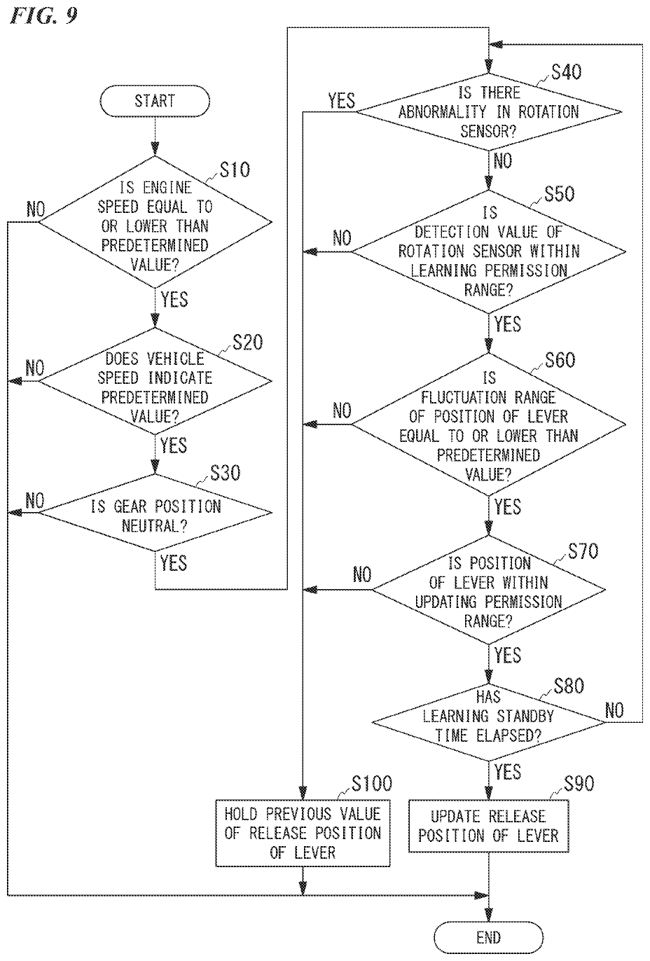

FIG. 9 is a flowchart illustrating a flow of the updating processing of the release position of the clutch lever in the clutch-by-wire system of the embodiment.

As illustrated in FIG. 9, the ECU 40 determines the learning permission conditions related to the states of the vehicle in Step S10 to Step S30.

In Step S10, the ECU 40 determines whether or not the first permission condition is satisfied. The first permission condition is that an engine speed is equal to or lower than a predetermined value. For example, a predetermined value in the first permission condition is set to the engine speed at the time of idling. When the engine speed is equal to or lower than the predetermined value (S10: YES), since erroneous detection of the position of the clutch lever 51 due to vibration of the engine can be curbed, the ECU 40 shifts to the processing of Step S20. When the engine speed is higher than the predetermined value (S10: NO), the ECU 40 ends the updating processing of the release position of the clutch lever 51.

In Step S20, the ECU 40 determines whether or not the second permission condition is satisfied. The second permission condition is that a speed of the vehicle indicates a predetermined value. A predetermined value in the second permission condition is zero. That is, the second permission condition is that the vehicle has stopped. When the speed of the vehicle is equal to or lower than the predetermined value (S20: YES), since erroneous detection of the position of the clutch lever 51 due to vibration from a road surface when the vehicle travels can be curbed, the ECU 40 shifts to the processing of Step S30. When the speed of the vehicle is higher than the predetermined value (S20: NO), the ECU 40 ends the updating processing of the release position of the clutch lever 51.

In Step S30, the ECU 40 determines whether or not the third permission condition is satisfied. The third permission condition is that a gear position is neutral. When the gear position is neutral (S30: YES), since reliability of determination results in Step S10 and Step S20 is improved, the ECU 40 shifts to the processing of Step S40. When the gear position is not neutral, there is a probability that the clutch lever 51 has been operated (grasped). For this reason, when the gear position is not neutral (S30: NO), the ECU 40 ends the updating processing of the release position of the clutch lever 51.

Subsequently, the ECU 40 determines the learning permission conditions related to the states of the clutch lever device 50 in Step S40 to Step S70.

In Step S40, the ECU 40 determines whether or not the fourth permission condition is satisfied. The fourth permission condition is that the rotation sensor 160 is normally operated. When it is determined that there is no abnormality in the rotation sensor 160 (S40: NO), the ECU 40 shifts to the processing of Step S50. When it is determined that there is an abnormality in the rotation sensor 160 (S40: YES), the ECU 40 holds a previous value without updating a previously stored position as the release position of the clutch lever 51 (Step S100) and ends the updating processing of the release position of the clutch lever 51.

In Step S50, the ECU 40 determines whether or not the fifth permission condition is satisfied. The fifth permission condition is that a detection value of the rotation sensor 160 is within a predetermined learning permission range. The predetermined learning permission range is set such that it includes the detection value of the rotation sensor 160 in a state in which the clutch lever 51 is not being operated. That is, the predetermined learning permission range is set with a range such that the detection value of the rotation sensor 160 in consideration of oscillation is included in a state in which the clutch lever 51 is positioned at the release position. When it is determined that the detection value of the rotation sensor 160 is within the predetermined learning permission range (S50: YES), the ECU 40 shifts to the processing of Step S60. When the detection value of the rotation sensor 160 is not within the predetermined learning permission range, there is a probability that the clutch lever 51 has been operated (grasped) or the rotation sensor 160 has malfunctioned. For this reason, when it is determined that the detection value of the rotation sensor 160 is not within the predetermined learning permission range (S50: NO), the ECU 40 holds a previous value of the release position of the clutch lever 51 (Step S100) and ends the updating processing of the release position of the clutch lever 51.

In Step S60, the ECU 40 determines whether or not the sixth permission condition is satisfied. The sixth permission condition is that a fluctuation range of an actual measurement value of the position of the clutch lever 51 is equal to or lower than a predetermined value. That is, the sixth permission condition is that a fluctuation range of the detection value of the rotation sensor 160 is equal to or lower than a predetermined value. For example, the fluctuation range of the detection value of the rotation sensor 160 is the difference between the upper limit and the lower limit of a detection value within a predetermined amount of time. When it is determined that the fluctuation range of the actual measurement value of the position of the clutch lever 51 is equal to or lower than the predetermined value (S60: YES), the ECU 40 shifts to the processing of

Step S70. When the fluctuation range of the actual measurement value of the position of the clutch lever 51 is higher than the predetermined value, there is a probability that the clutch lever 51 has been operated (grasped). For this reason, when it is determined that the fluctuation range of the position of the clutch lever 51 is higher than the predetermined value (S60: NO), the ECU 40 holds a previous value of the release position of the clutch lever 51 (Step S100) and ends the updating processing of the release position of the clutch lever 51.

In Step S70, the ECU 40 determines whether or not the seventh permission condition is satisfied. The seventh permission condition is that the clutch lever 51 is positioned within a predetermined updating permission range based on the release position of the clutch lever 51 stored by the ECU 40. That is, the seventh permission condition is that the detection value of the rotation sensor 160 is within a voltage range corresponding to the predetermined updating permission range based on the release position voltage. The predetermined updating permission range is larger on the upstream side in the operation direction G (release side of the clutch lever 51) than on the downstream side in the operation direction G (grasp side of the clutch lever 51) with respect to the release position of the clutch lever 51 stored by the ECU 40. In other words, an end portion of the predetermined updating permission range on the downstream side in the operation direction G is set at a position closer to the release position of the clutch lever 51 than on an end portion thereof on the upstream side in the operation direction G. When it is determined that the clutch lever 51 is positioned within the predetermined updating permission range (S70: YES), the ECU 40 shifts to the processing of Step S80. When the clutch lever 51 is not positioned within the predetermined updating permission range, there is a probability that the clutch lever 51 is at a position that is drastically shifted from the release position. For this reason, when it is determined that the clutch lever 51 is not positioned within the predetermined updating permission range (S70: NO), the ECU 40 holds a previous value of the release position of the clutch lever 51 (Step S100) and ends the updating processing of the release position of the clutch lever 51.

Subsequently, the ECU 40 determines whether or not a predetermined learning standby time has elapsed after all the predetermined learning permission conditions are satisfied in Step S80. For example, the predetermined learning standby time is set with a timing as a starting point at which the processing of Step S80 is performed first in a series of processing of Step S10 to Step S100. When it is determined that the predetermined learning standby time has not elapsed (S80: NO), the ECU 40 performs the processing of Step S40 again. When it is determined that the predetermined learning standby time has elapsed (S80: YES), the ECU 40 shifts to the processing of Step S90. That is, the ECU 40 repeatedly determines the learning permission conditions related to the states of the clutch lever device 50 until the predetermined learning standby time elapses.

In Step S90, the ECU 40 measures the position of the clutch lever 51 and updates the previously stored release position. Specifically, the ECU 40 acquires the detection value of the rotation sensor 160 and updates the release position voltage. At this time, the ECU 40 provides an upper limit for an updating range with respect to the stored release position voltage and updates the release position voltage. The ECU 40 may update the detection value of the rotation sensor 160 as a release position voltage as it stands without providing an upper limit for the updating range.

As stated above, the position of the clutch lever 51 when the predetermined learning permission conditions are satisfied is measured, and the updating processing of updating a position which is previously stored as a release position is completed.

The ECU 40 periodically repeats the processing of Step S10 to Step S100 after power is supplied to the vehicle. Accordingly, the ECU 40 performs the updating processing every time a predetermined amount of time elapses in a state in which all the predetermined learning permission conditions are satisfied.

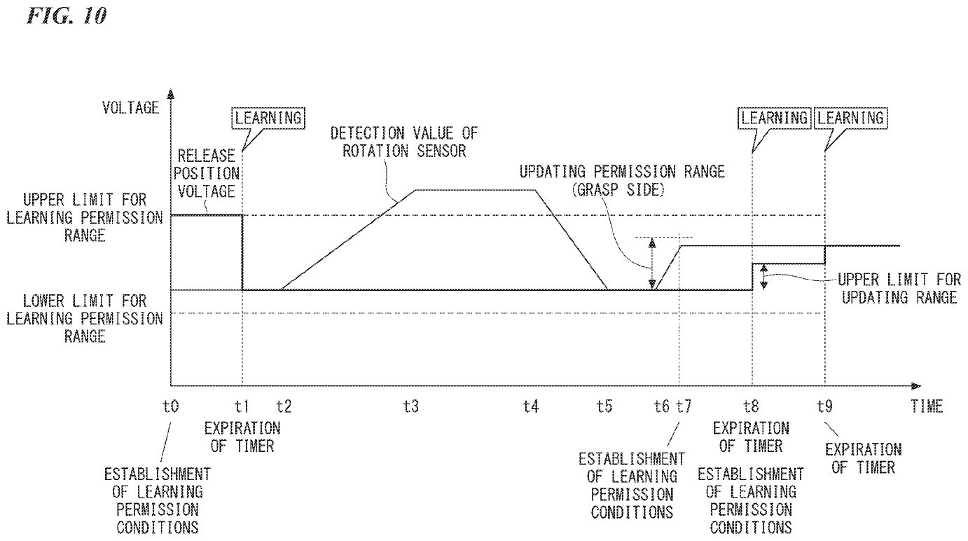

Next, with reference to FIG. 10, an example of the updating processing of the release position of the clutch lever 51 in the clutch-by-wire system of the present embodiment will be described.

FIG. 10 is a timing chart illustrating an example of the updating processing of the release position of the clutch lever 51 in the clutch-by-wire system of the embodiment. The vertical axis in FIG. 10 indicates the detection value (output voltage) of the rotation sensor 160. The horizontal axis in FIG. 10 indicates the time.

In the example illustrated in FIG. 10, at a time t0, the ECU 40 stores an upper limit voltage for the learning permission range as a release position voltage. At the time t0, the position of the clutch lever 51 measured by the ECU 40 is within the learning permission range described above. At the time t0, the ECU 40 determines that all the predetermined learning permission conditions described above are satisfied and starts counting of the predetermined learning standby time in Step S80.

During a time period between the time t0 and a time t1, the ECU 40 repeatedly performs the processing of Step S40 to Step S80. At the time t1, since the predetermined learning standby time has elapsed from the time t0 in a state in which all the predetermined learning permission conditions are satisfied, the ECU 40 measures the position of the clutch lever 51 and updates the previously stored release position. Specifically, the ECU 40 updates the detection value of the rotation sensor 160 as a release position voltage as it stands.

During a time period from a time t2 to a time t5 after the time t1, the clutch lever 51 is operated and the detection value of the rotation sensor 160 fluctuates with respect to the release position voltage. During a time period from the time t2 to the time t3, the detection value of the rotation sensor 160 gradually increases. That is, during a time period from the time t2 to the time t3, the clutch lever 51 is in a process of being displaced in the operation direction G (refer to FIG. 8), and the sixth permission condition described above is not satisfied. During a time period from the time t3 to the time t4, since the clutch lever 51 is not positioned within the predetermined learning permission range, the fifth learning permission condition described above is not satisfied. During a time period from the time t4 to the time t5, the detection value of the rotation sensor 160 gradually decreases. That is, during a time period from the time t4 to the time t5, the clutch lever 51 is in a process of being displaced in a direction opposite to the operation direction G, and the sixth permission condition described above is not satisfied.

During a time period from a time t6 to a time t7 after the time t5, the detection value of the rotation sensor 160 increases in a state in which the clutch lever 51 is positioned at the release position, and a difference between the detection value and the release position voltage stored by the ECU 40 is caused. At the time t7, the detection value of the rotation sensor 160 changes to a stable state within the learning permission range described above and within the voltage range corresponding to the updating permission range described above. At the time t7, the ECU 40 determines that all the predetermined learning permission conditions described above are satisfied and starts counting of the predetermined learning standby time in Step S80.

During a time period between the time t7 and a time t8, the ECU 40 repeatedly performs the processing of Step S40 to Step S80. At the time t8, since the predetermined learning standby time has elapsed from the time t7 in a state in which all the predetermined learning permission conditions are satisfied, the ECU 40 measures the position of the clutch lever 51 and updates the previously stored release position. Specifically, since a difference between the detection value of the rotation sensor 160 and the release position voltage is larger than the upper limit for the updating range of the updating permission range, the ECU 40 updates the release position voltage by the amount of the upper limit for the updating range with respect to the stored release position voltage. At the time t8, since the predetermined learning permission conditions described above are continuously satisfied, the ECU 40 starts counting of the predetermined learning standby time in Step S80.

During a time period between the time t8 and a time t9, the ECU 40 repeatedly performs the processing of Step S40 to Step S80. At the time t9, since the predetermined learning standby time has elapsed from the time t8 in a state in which all the predetermined learning permission conditions are satisfied, the ECU 40 measures the position of the clutch lever 51 and updates the previously stored release position. Specifically, since the difference between the detection value of the rotation sensor 160 and the release position voltage is smaller than the upper limit for the updating range of the updating permission range, the ECU 40 updates the detection value of the rotation sensor 160 as a release position voltage as it stands.

As described above, the clutch-by-wire system of the present embodiment repeatedly performs the updating processing of the release position of the clutch lever 51 after power is supplied. Accordingly, for instance, even if erroneous learning of the release position of the clutch lever 51 occurs, the erroneous learning of the release position of the clutch lever 51 can be promptly canceled without waiting for next power supply. Thus, in the clutch-by-wire system in which an operation range of the clutch lever 51 is learned based on the stored release position of the clutch lever 51, erroneous learning of the operation range of the clutch lever 51 can be promptly canceled.

In addition, in the present embodiment, the updating processing of the release position of the clutch lever 51 is performed every time a predetermined amount of time elapses in a state in which the predetermined learning permission conditions are satisfied after power is supplied. Accordingly, when the predetermined learning permission conditions are satisfied, for instance, even if erroneous learning of the release position of the clutch lever 51 occurs, the erroneous learning of the release position of the clutch lever 51 can be canceled before a rider operates the clutch lever 51.

In addition, in the present embodiment, the learning permission conditions include a condition that the detection value of the rotation sensor 160 is within the predetermined learning permission range. Here, a state in which the detection value of the rotation sensor 160 is a value outside of the predetermined learning permission range corresponds to a state in which the clutch lever 51 is positioned at a position that is drastically shifted from an original release position uniquely set in accordance with the shape of the clutch lever device 50. For this reason, it is possible to curb performing of the updating processing in a state inappropriate for updating the release position of the clutch lever 51, such as a state in which the clutch lever 51 is being grasped (unreleased state) or a state in which the rotation sensor 160 has malfunctioned. Therefore, erroneous learning of the release position of the clutch lever 51 can be curbed.

In addition, the learning permission conditions include a condition that the clutch lever 51 is positioned within the predetermined updating permission range based on the stored release position of the clutch lever 51. Here, a state in which the clutch lever 51 is positioned outside of the predetermined updating permission range corresponds to a state in which the clutch lever 51 is positioned at a position that is shifted from the stored release position of the clutch lever 51 in a relatively significant manner. For this reason, it is possible to curb performing of the updating processing in a state inappropriate for updating the release position of the clutch lever 51, such as a state in which the clutch lever 51 is being grasped or a state in which the rotation sensor 160 has malfunctioned. Therefore, erroneous learning of the release position of the clutch lever 51 can be curbed.

In addition, the predetermined updating permission range is larger on the release side than on the grasp side of the clutch lever 51 with respect to the stored release position of the clutch lever 51. Accordingly, when the clutch lever 51 stands still in a state of being grasped by a rider, it is possible to effectively curb updating of the release position of the clutch lever 51. Therefore, erroneous learning of the release position of the clutch lever 51 can be curbed.

In addition, the learning permission conditions include a condition that the fluctuation range of the actual measurement value of the position of the clutch lever 51 is equal to or lower than the predetermined value. The position of the clutch lever 51 is likely to vibrate in a state in which the clutch lever 51 is being grasped. For this reason, by performing the updating processing only when the fluctuation range of the actual measurement value of the position of the clutch lever 51 is equal to or lower than the predetermined value, it is possible to curb updating of the release position of the clutch lever 51 when the clutch lever 51 is being grasped. Therefore, erroneous learning of the release position of the clutch lever 51 can be curbed.

In addition, the learning permission conditions include a condition that the engine speed is equal to or lower than the predetermined value. Accordingly, it is possible to curb occurrence of an error in measurement results of the position of the clutch lever 51 caused by vibration of the clutch lever 51 due to vibration accompanied by rotation of the engine. Therefore, erroneous learning of the release position of the clutch lever 51 can be curbed.

In addition, the learning permission conditions include a condition that the speed of the vehicle indicates the predetermined value. Accordingly, by performing the updating processing of the release position of the clutch lever 51 restrictively in a state in which the speed of the vehicle is zero (vehicle stop state), it is possible to curb occurrence of an error in measurement results of the position of the clutch lever 51 caused by vibration of the clutch lever 51 due to vibration from a road surface when the vehicle travels. Therefore, erroneous learning of the release position of the clutch lever 51 can be curbed.

In addition, the learning permission conditions include a condition that the gear position is neutral. Here, when the gear position is not neutral, there is a high probability that the vehicle is traveling, and there is a high probability that the engine is rotating at a higher speed than a speed at the time of idling. For this reason, by performing the updating processing of the release position of the clutch lever 51 restrictively in a state in which the gear position is neutral, it is possible to curb occurrence of an error in measurement results of the position of the clutch lever 51 caused by vibration of the clutch lever 51 due to at least one of vibration from a road surface and vibration accompanied by rotation of the engine. Therefore, erroneous learning of the release position of the clutch lever 51 can be curbed.

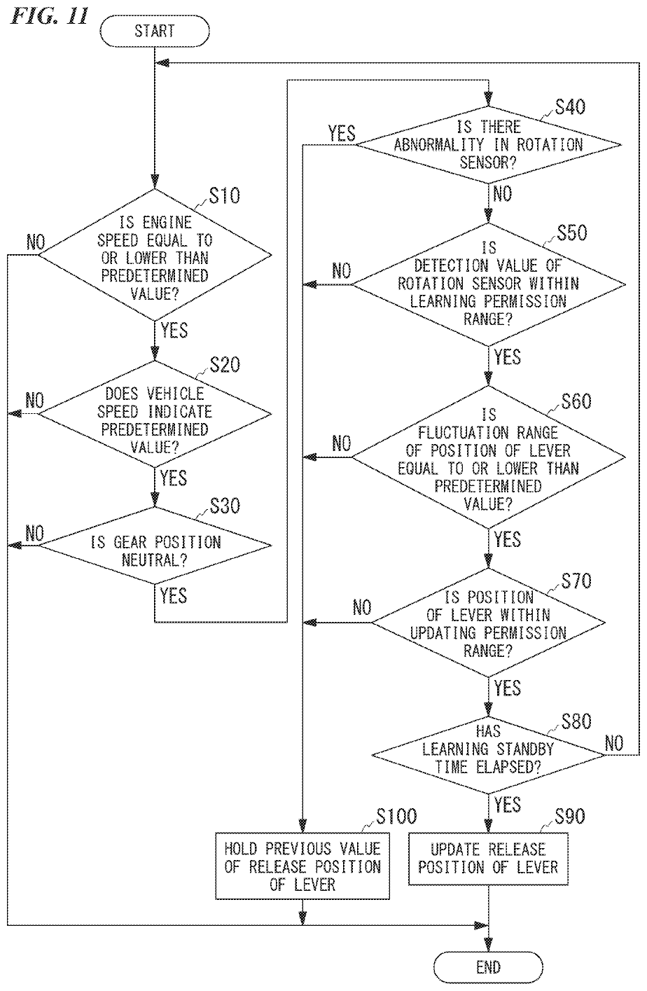

In the foregoing embodiment, the ECU 40 repeatedly determines the learning permission conditions related to the states of the clutch lever device 50 until the predetermined learning standby time elapses, but the embodiment is not limited thereto. For example, as illustrated in FIG. 11, the ECU 40 may repeatedly determine all the learning permission conditions until the predetermined learning standby time elapses. That is, when it is determined that the predetermined learning standby time has not elapsed (S80: NO), the ECU 40 may perform the processing of Step S10 again.

The present invention is not limited to the foregoing embodiment which has been described with reference to the drawings, and various modification examples can be considered within the technical scope thereof.

For example, the learning permission conditions for performing the updating processing of the release position of the clutch lever 51 may only be some of the learning permission conditions of the foregoing embodiment.

In addition, in the foregoing embodiment and the modification example thereof, when it is determined that the predetermined learning standby time has not elapsed in the updating processing of the release position of the clutch lever 51, the ECU 40 repeatedly determines all the learning permission conditions related to the states of the clutch lever device 50. However, the embodiment is not limited thereto. When it is determined that the predetermined learning standby time has not elapsed, the ECU 40 may repeatedly determine only some of the learning permission conditions related to the states of the clutch lever device 50.

In addition, in the foregoing embodiment, the predetermined updating permission range is larger on the release side of the clutch lever 51 than on the grasp side of the clutch lever 51 with respect to the release position of the clutch lever 51 stored by the ECU 40, but the embodiment is not limited thereto. For example, the predetermined updating permission range may be the same on the grasp side and the release side of the clutch lever 51 with respect to the release position of the clutch lever 51 stored by the ECU 40.

Furthermore, within a range not departing from the gist of the present invention, the constituent elements in the foregoing embodiment can be suitably replaced with known constituent elements.

### INDUSTRIAL APPLICABILITY

According to the foregoing clutch-by-wire system, updating processing of updating a position which is previously stored as a release position of a clutch lever is repeatedly performed after power is supplied. Therefore, for instance, even if erroneous learning of the release position of the clutch lever occurs, the erroneous learning of the release position of the clutch lever can be promptly canceled without waiting for the next power supply. Thus, in the clutch-by-wire system in which an operation range of the clutch lever is learned based on the stored release position of the clutch lever, erroneous learning of the operation range of the clutch lever can be promptly canceled.

### REFERENCE SIGNS LIST

51 Clutch lever

160 Rotation sensor (detection device)

What is claim is:

1. A clutch-by-wire system for measuring a position of a clutch lever when predetermined learning permission conditions are satisfied and performing updating processing of updating a position which is previously stored as a release position of the clutch lever,
wherein the learning permission conditions include a condition that a fluctuation range of an actual measurement value of the position of the clutch lever is equal to or lower than a predetermined value, and
wherein the updating processing is repeatedly performed after power is supplied.

2. The clutch-by-wire system according to claim 1,
wherein the updating processing is performed every time a predetermined amount of time elapses in a state in which the predetermined learning permission conditions are satisfied after power is supplied.

3. The clutch-by-wire system according to claim 1 comprising:
a detection device that detects an operation amount of the clutch lever,
wherein the learning permission conditions include a condition that a detection value of the detection device is within a predetermined learning permission range.

4. The clutch-by-wire system according to claim 1,
wherein the learning permission conditions include a condition that the clutch lever is positioned within a predetermined updating permission range based on the stored release position of the clutch lever.

5. The clutch-by-wire system according to claim 4, wherein the predetermined updating permission range is larger on a release side than on a grasp side of the clutch lever with respect to the stored release position of the clutch lever.

6. (canceled)

7. The clutch-by-wire system according to claim 1,
wherein the learning permission conditions include a condition that an engine speed is equal to or lower than a predetermined value.

8. The clutch-by-wire system according to claim 1,
wherein the learning permission conditions include a condition that a speed of a vehicle indicates a predetermined value.

9. The clutch-by-wire system according to claim 1,
wherein the learning permission conditions include a condition that a gear position is neutral.
